(19) United States
(12) Patent Application Publication
(10) Pub. No.: US 2004/0192816 A1
(43) Pub. Date: Sep. 30, 2004

(54) Product in subdivided form for preparing crosslinkable elastomeric compositions

(76) Inventors: Maurizio Galimberti, Milano (IT); Cristiano Puppi, Guanzate (IT); Francesco Romani, Sarzana (IT); Enrico Albizatti, Lesa (IT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/474,639

(22) PCT Filed: Apr. 9, 2002
(86) PCT No.: PCT/EP02/03943

Related U.S. Application Data
(60) Provisional application No. 60/285,270, filed on Apr. 23, 2001.

(30) Foreign Application Priority Data
Apr. 13, 2001 (EP) 01109205.3

(51) Int. Cl. C08J 3/00

(52) U.S. Cl. 524/275; 524/425; 524/447; 524/437; 524/493

(57) ABSTRACT

Product in subdivided form comprising: a) at least one additive for crosslinkable elastomeric compositions; and b) a thermoplastic binder comprising at least (i) one copolymer ethylene with at least one aliphatic or aromatic α-olefin, and optionally a polyene, said copolymer being characterized by a molecular weight distribution (MWD) index of less than 5 and a melting enthalpy (ΔHₘ) of at least 30 J/g. Said product in subdivided form is particularly useful for preparing crosslinkable elastomeric compositions.

The present invention relates to a product in subdivided form for preparing crosslinkable elastomeric compositions.

More particularly, the present invention relates to a product in subdivided form comprising at least one additive for crosslinkable elastomeric compositions and a thermoplastic binder comprising at least one copolymer of ethylene with at least one α-olefin.

As is known, additives for elastomer or plastic compositions are generally in the form of fine dusts or liquids. It is also known that said additives are difficult to handle and, consequently, may cause problems during the preparation of said compositions, such as, for example, a non-homogeneous dispersion in the final composition, the need for relatively long mixing times, difficulty in using automatic addition systems. In addition, especially in the case of fine dusts, special safety measures need to be adopted in order to prevent them from diffusing into the environment, which may give rise, for example, to contamination of other materials or lead to risks for the environment and the health of the operators.

It is also known that, in the preparation of plastic or elastomeric compositions, a number of additives which have an important role in the final composition are added in small amounts, generally in amounts of between 0.1% and 5% by weight relative to the weight of the final composition. However, said additives need to be added in such a way that the process conditions and the properties of the final manufactured product are reproducible: as a matter of fact, small variations in the amounts actually used or a non-homogeneous distribution of the abovementioned additives in the final Composition may cause variations in the properties of the manufactured product obtained therefrom. Examples of additives of the abovementioned type are: vulcanizing agents, crosslinking agents, vulcanization accelerators and retarders, degradation stabilizers, anti-ozone agents, antioxidants, pigments, colorants, crosslinking modifiers, chemical-product stabilizers and heat stabilizers, resins, inhibitors, catalysts capable of extending polymer chains, and the like.

For the purpose of overcoming the abovementioned drawbacks, a number of solutions have been proposed.

For example, patent GB 1 389 342 discloses additives in granular form comprising at least one additive for rubbers and at least one substantially saturated elastomeric polymer with thermoplastic properties and, optionally, a dispersant. Said elastomeric polymer is preferably readily mixable and compatible with natural and/or synthetic rubbers. Examples of additives for rubbers which may be used for this purpose include: expanding agents such as sodium bicarbonate; vulcanization accelerators such as hexamethylene tetramine, tetramethyl thiuram disulphide, diethyl thiourea; crosslinking agents such as sulphur; anti-ageing additives such as N-isopropyl-N-phenyl-p-phenylenediamine; activators of various types such as lead oxide, lead dioxide, red lead and zinc oxide. Examples of elastomeric polymers which may be used for this purpose include: ethylene/vinyl acetate copolymers, ethylene/propylene copolymers, polyisobutylene, and blends thereof. Examples of dispersants which may be used for this purpose include: esters or fatty alcohols, or zinc oleate. The blend of additive, elastomeric polymer and, optionally, dispersant, may be prepared in the mixers commonly used in the rubber industry, such as, for example, ram kneaders or mixing rolls. The subsequent granulation may be carried out by means of granulators normally used in the rubber industry. In this way, it would be possible to obtain free-flowing, non-tacky granules which may be stored in silos and added automatically during the process for preparing elastomeric compositions.

U.S. Pat. No. 4,670,181 describes a method for preparing additive granules for rubbers or polymers, which are free-flowing and free of powder, in which a process coadjuvant (“processing aid system”) is used comprising, per 100 parts by weight of additive: (1) from 0.2 to about 4 parts by weight of a water-soluble high molecular weight binder chosen from the group consisting of partially or totally hydrolysed polyvinyl alcohol, alkyl or hydroxyalkyl cellulose, polyacrylamides, acrylic acid/acrylamide copolymers, amides, polyacrylic acid polymers, polyethylene oxides; (2) from 0.2 to 1 part by weight of a water-soluble or water-dispersible surfactant; and (3) water. Said method is particularly useful when the granules are obtained by means of an extrusion process, more particularly when a screw extruder is used. Examples of additives which may be used include: accelerators, vulcanizing agents, pigments, stabilizers, antioxidants, crosslinking agents, reinforcing fillers, and the like.

U.S. Pat. No. 4,092,285 describes a composition comprising from about 60% to about 95% by weight of an additive for rubbers or plastics and from about 5% to about 40% by weight of a binder, said binder comprising: at least one compound chosen from (i) liquids that are compatible with said rubbers or plastics and with the other components of the binder, and (ii) waxes with a melting point of between 55° C. and 80° C.; and a polymer with a high molecular weight (at least about 50,000), said polymer being capable of producing, when combined with the other components of the binder, a non-tacky binder which remains in gel form at temperatures below about 53° C. and which is capable of returning to liquid form at temperatures above about 53° C. Examples of high molecular weight polymers which may be used for this purpose include: ethylene/propylene/diene terpolymers (EPDM), polyethylene chlorosulphonate (Hypalon®), natural rubber, neoprene with high hardness and high crystallization speed, and the like. Examples of additives which may be used for this purpose include: vulcanizing agents, crosslinking agents, vulcanization accelerators and retarders, degradation stabilizers, anti-ozone agents, antioxidants, foaming agents, foaming agent activators, pigments, colorants, crosslinking modifiers, flame retardants, chemical-product stabilizers and heat stabilizers, resins, inhibitors, catalysts capable of extending polymer chains, and the like. Said additives are mixed with the abovementioned binder in a mixer at high speed, such as, for example, a Henschel mixer, thus producing particles of irregular form which may be subsequently transformed into other forms such as, for example, granules, strips, cylinders, pearls, and the like. The particles obtained are said to be free-flowing and capable of being accurately added and of dispersing homogeneously and quickly in the elastomeric or plastic compositions into which they are added.

Patent application DE 196 19 509 describes a binder composition for additives for natural and/or synthetic rubbers, comprising: from 36.25 to 23.75 parts by weight of a trans-polyoctenamer with a Mooney viscosity ML (1+4) at 100° C. of between 5 and 10; from 12.50 to 25.00 parts by weight of a polyolefinic elastomer (POE) obtained with metallocene catalysts, having a Mooney viscosity ML (1+4) at 100° C. of between 5 and 8; from 1 to 3 parts by weight of a paraffin wax with a solidification point of between 40° C. and 65° C.; from 1 to 3 parts by weight of a fatty acid or a derivative thereof, containing from 13 to 18 carbon atoms and having an iodine number of between 10 and 12; from 5 to 20 parts by weight of a liquid ethylene/propylene elastomer having a Haake viscosity of between 5000 mPa and 15,000 mPa; and from 20 to 60 parts by weight of paraffinic mineral oil having a VGC (ViscosityGravity Constant) value of between 0.80 and 0.85. Examples of additives which may be used for this purpose are chosen, for example, from: vulcanization accelerators, anti-ageing agents, vulcanization activators, or mixtures thereof. Said composition is used to produce rubber additive granules by means of a continuous process which comprises: weighing out the components of the abovementioned composition, premixing said components in an extruder at a temperature of between 50° C. and 80° C., continuing the phase of mixing, homogenizing, granulating and cooling, in a single stage, in a thermostatically regulated compactor, working at a temperature of between 50° C. and 80° C. For the purpose of promoting dispersion in the final elstomeric composition, the granules obtained have a low melting point.

Patent application EP 728 797 describes the use of a trans-polyoctenamer combined with silica as a vehicle for fluid additives for elastomeric materials. The use of trans-polyoctenamer combined with silica is said to make it possible to obtain a non-tacky masterbatch which may be readily converted into granules. In the case when said masterbatch is too fragile on account of the crystallinity of the trans-polyoctenamer, the latter product may be replaced, up to a maximum of 10%, with an ethylene/propylene copolymer (EPM) (in one example, an ethylene/propylene copolymer with a Mooney viscosity ML (1+4) at 125° C. equal to 48 is used) Examples of fluid additives which may be used for this purpose include: vinylsilanes and mercaptosilanes, sulphur-containing silanes, fluid butadienes containing silane groups, di- and polyglycols. Said masterbatch may be conveniently produced using an extruder. The granules obtained are said to be readily processable in elastomer blends and have good shelf life.

In the Applicant's view, the additives for elastomeric compositions in granular form which have been proposed hitherto in the prior art are not capable of ensuring high, reliability and consistent results. In particular, the Applicant believes that a product in subdivided form containing at least one additive for elastomeric compositions needs to have the following characteristics:

high flowability at the working temperature, even following a prolonged period of storage at room temperature or even at higher temperatures;

high size stability, even following intense mechanical stresses, both of friction and of compression, in order to avoid the formation of dusts and/or changes in the shape and/or dimensions of the granule, which would lead to irregularity in feeding and metering the product;

high percentage of additive incorporated in the binder so as to minimize the amount of said binder present in the elastomeric composition, which might lead, in a few cases, to undesirable and uncontrollable changes in the properties of the final elastomeric manufactured product.

The Applicant has now found that it is possible to obtain a product in subdivided form, in particular for the preparation of crosslinkable elastomeric compositions, having the desired combination of properties as described above, by using a binder with thermoplastic properties comprising at least one copolymer of ethylene with at least one α-olefin having a molecular weight distribution (MWD) index of less than 5 and a melting enthalpy of, at least 30 J/g.

According to a first aspect, the present invention thus relates to a product in subdivided form comprising:

(a) at least one additive for crosslinkable elastomeric compositions; and

(b) a thermoplastic binder comprising at least (i) one copolymer of ethylene with at least one aliphatic or aromatic α-olefin, and optionally a polyene, said copolymer being characterized by a molecular weight distribution (MWD) index of less than 5, preferably between 1.5 and 3.5, and a melting enthalpy (ΔHₘ) of at least 30 J/g, preferably between 34 J/g and 150 J/g.

Said molecular weight distribution index is defined as the ratio between the weight-average molecular weight (M_{w}) and the number-average molecular weight (Mₙ) and may be determined, according to conventional techniques, by gel permeation chromatography (GPC).

Said melting enthalpy (ΔHₘ) may be determined by means of differential scanning calorimetry and relates to the melting peaks found in the temperature range from 0° C. to 200° C.

According to a further aspect, the present invention relates to a process for preparing a crosslinkable elastomeric composition, comprising the following stages:

mixing a base polymer comprising at least one elastomeric polymer with at least one reinforcing filler and at least one plasticizer;

adding at least one additive capable of modifying or improving the properties of said elastomeric composition;

mixing and dispersing said reinforcing filler, said plasticizer and said additive in said elastomeric polymer;

in which said At least one additive is added as a product in subdivided form comprising said at least one additive dispersed in a thermoplastic binder comprising at least (i) one copolymer of ethylene with at least one aliphatic or aromatic α-olefin, and optionally a polyene, said copolymer being characterized by a molecular weight distribution (MWD) index of less than 5, preferably between 1.5 and 3.5, and a melting enthalpy (ΔHₘ) of at least 30 J/g, preferably between 34 J/g and 150 J/g.

The abovementioned process may be carried out in continuous or batchwise-mode.

According to one preferred embodiment, said copolymer (i) is present in an amount of between 20% and 100% by weight relative to the weight of said thermoplastic binder (b), preferably between 35% and 100% by weight.

According to a further preferred embodiment, said additive (a) is present in an amount of between 40% and 95% by weight relative to the total weight of said product in subdivided form, preferably between 50% and 90% by weight, even more preferably between 70% and 80% by weight.

According to a further preferred embodiment, said thermoplastic binder (b) also comprises from 0% to 80% by weight, relative to the weight of said thermoplastic binder (b) and preferably from 0% to 65% by weight, of at least (ii) one polymer obtained by a metathesis reaction of a cycloalkene.

According to a further preferred embodiment, said thermoplastic binder (b) also comprises from 0% to 80% by weight, relative to the weight of said thermoplastic binder (b), preferably from 0% to 65% by weight, of at least (iii) one copolymer of ethylene with at least one ester containing an ethylenic unsaturation.

According to a further preferred embodiment, said products in subdivided form also comprise from 0% to 40% by weight, relative to the weight of said additive (a), preferably from 10% to 20% by weight, of at least (iv) one elastomeric polymer.

According to a further preferred embodiment, said products in subdivided form also comprise from 0% to 60% by weight, relative to the weight of said additive (a), preferably from 5% to 40% by weight, of at least (v) one reinforcing filler.

According to a further preferred embodiment, said products in subdivided form also comprise from 0% to 40% by weight, relative to the weight of said additive (a), preferably from 5% to 10% by weight, of at least (vi) one plasticizer.

For the purpose of the present description and the subsequent claims, the expression “product in subdivided form” generally means a product of granular form, with an average diameter generally of between 0.5 mm and about, 3 mm, preferably between 1 mm and 2 mm, and a length generally between about 1 mm and 4 mm, preferably between 1.5 mm and 3 mm.

According to a further preferred embodiment, said products in subdivided form have a Shore A hardness of at least 45 and a Shore D hardness of not more than 65 (measured according to ASTM standard D2240-00). The Shore D hardness is preferably between 20 and 60.

Additives (a) for crosslinkable elastomeric compositions which may be used in the present invention include, in general, components other than elastomeric polymers, reinforcing fillers and plasticizers, which may be used to modify or improve the properties of elastomeric compositions and which belong to various classes of chemical products. Preferably, said additives (a) belong to the following classes:

(a1) crosslinking agents;

(a2) accelerators;

(a3) thermosetting resins;

(a4) activators;

(a5) retardants;

(a6) adhesion promoting agents;

(a7) protective agents;

(a8) coupling agents;

(a9) condensation catalysts.

Specific examples of crosslinking agents (a1) which may be used in the present invention include:

soluble sulphur (crystalline sulphur);

insoluble sulphur (polymeric sulphur);

sulphur dispersed in oil (for example 33% sulphur known under the trade name Crystex® OT33 from Flexsys);

sulphur donors such as, for example, tetramethylthiuram disulphide (TMTD), tetraethylthiuram disulphide (TETD); tetrabutylthiuram disulphide (TBTD); dimethyldiphenylthiuram disulphide (MPTD); pentamethylenethiuram tetra- , or hexasulphide (DPTT); morpholinobenzothiazole disulphide (MBSS); N-oxydiethylenedithiocarbamyl-N′-oxydiethylenesulphenamide (OTOS), dithiodimorpholine (DTM or DTDM); caprolactam disulphide (CLD);

peroxides such as, for example, 1,4-bis(t-butylperoxyisopropyl)benzene, 1,1′-bis(t-butylperoxy)-3,3,5-trimethylcyclohexane, dicumyl peroxide, butyl ester of 3,3-di-t-butylperoxybutyric acid; 2,5-bis(t-butylperoxy)-2,5-dimethylhexane, dibenzoyl peroxide, bis(2,4-dichlorobenzoyl) peroxide;

quinones such as, for example, para-quinonedioxime (GMF), dibenzoyl-para-quinonedioxime (dibenzo GMF), chloranil quinonimine (Vulklor);

phenolic resins, in particular phenolic resins containing methylol end groups,

diurethanes, in particular products derived from the reaction of 4,4′-diphenylmethane diisocyanate with the oxime-quinone tautomeric form of p-nitrosophenol;

diamines such as, for example, hexamethylenediamine carbamate, N,N′-dicinnamylidene-1,6-hexanediamine.

Specific examples of accelerators (a2) which may be used in the present invention include:

thiazoles such as, for example, 2-mercaptobenzothiazole (MBT), zinc salt of 2-mercaptobenzothiazole (ZMBT), 2-mercaptobenzothiazole disulphide (MBTS), 2,4-dinitrophenylmercaptobenzothiazole;

sulpheanamides such as, for example, N-cyclohexyl-2-benzothiazylsulphenamide (CBS), N-oxydiethylene-2-benzothiazylsulphenamide (OBS), N-t-butyl-2-benzothiazylsulphenamide (TBBS), N,N-dicyclohexyl-2-benzothiazylsulphenamide (DCBS);

guanidines such as, for example, diphenylguanidine (DPG), di-o-tolylguanidine (DOTG), o-tolylbiguanide (OTGB);

thiurams such as: thiuram monosulphides [for example tetramethylthiuram monosulphide (TMTM)]; thiuram disulphides [for example tetramethylthiuram disulphide (TMT or TMTD)], tetraethylthiuram disulphide (TETD), tetrabutylthiuram disulphide (TBTD or TBTS), dimethyldiphenylthiuram disulphide (MPTD), diethyldiphenylthiuram disulphide (EPTD)]; thiuram tetrasulphides (for example pentamethylenethiuram tetrasulphide); thiuram hexasulphides (pentamethylenethiuram hexasulphide);

dithiocarbamates such as, for example, zinc N-dimethyldithiocarbamate (ZDMC), zinc N-diethyldithiocarbamate (ZDEC), zinc N-dibutyldithiocarbamate (ZDBC), zinc N-ethylphenyldithiocarbamate (ZEPC), zinc N-pentamethylenedithiocarbamate (ZCMC), zinc N-dibenzyldithiocarbamate (ZBEC), tellurium N-diethyldithiocarbamate (Te DEC or TDEC), selenium N-diethyldithiocarbamate (Se DEC), cadmium N-diethyldithiocarbamate (Cd DEC), copper N-diethyldithiocarbamate (Cu DEC), lead N-diethyldithiocarbamate (LDMC), lead N-diamyldithiocarbamate (LDAC), bismuth N-dimethyldithiocarbamate (Bi DMC), piperidine N-pentamethylenedithiocarbamate (PPC), or mixtures of dithiocarbamates;

Schiff's bases and other amino accelerators such as, for example, condensation products between acrolein homologues with aromatic bases; butyraldehyde-aniline (BAA) condensation products; tricrotonylidenetetramine (TLT); cyclohexylethylamine (CEA), polyethylenepolyamine (PEP), hexamethylenetetramine (HEXA);

xanthogenates such as, for example, zinc isopropylxanthogenate (ZIX), zinc butylxanthogenate (ZBX), sodium isopropylxanthogenate (NaIX), dibutylxanthogenate disulphide (DBX).

Specific examples of thermosetting resins (a3) which may be used in the present invention include:

hydrocarbon resins such as, for example, α-methylstyrene-base resins (Kristalex® F-85 from Hercules);

cumarone-based resins (Cumar® from Neville Chemical).

Specific examples of activators (a4) which may be used in the present invention include:

zinc compounds such as, for example, ZnO, ZnCO₃, zinc salts of saturated or unsaturated fatty acids containing from 8 to 18 carbon atoms, such as, for example, zinc stearate, preferably formed in situ in the mixture from ZnO and fatty acid, and also BiO, PbO, PbO₃O₄ and PbO₂;

1,5-difurfuryl-1,4-pentadiene-3-one, triallyl cyanurate, triallyl isocyanurate, triallyl phosphate, ethylene glycol dimethacrylate (EDMA), trimethyloipropane trimethacrylate (TPTA), N,N′-m-phenylenedimaleimide.

Specific examples of retardants (a5) which may be used in the present invention include:

carboxylic acids or derivatives thereof such as, for example, benzoic acid, salicylic acid, anhydride of phthalic acid (PTA);

phthalimide derivatives such as, for example, N-cyclohexylthiophthalimide;

diphenylamine derivatives such as, for example, N-nitrosodiphenylamine (NDPA).

Specific examples of adhesion promoting agents (a6) which may be used in the present invention include:

hexamethylenetetramine (HMT);

melamine derivatives such as, for example, hexamethoxymethylmelamine (HMMM);

phenol derivatives such as, for example, m-hydroxyphenol (resorcinol).

Specific examples of protective agents (a7) which may be used according to the present invention include:

amine derivatives such as, for example, N-isopropyl-N′-phenyl-p-phenylenediamine (IPPD), N-(1,3-dimethylbutyl)-N′-p-phenylenediamine (6PPD), N,N′-bis(1,4-dimethylpentyl)-p-phenylenediamine (77PD), N,N′-bis(1-ethyl-3-methylpentyl)-p-phenyldiamine (DOPD), N,N′-diphenyl-p-phenylenediamine (DPPD), N,N′-ditolyl-p-phenylenediamine (DTPD), N,N′-di-β-naphthyl-p-phenylenediamine (DNPD), phenyl-α-naphthylamine (PAN) and phenyl-β-naphthylamine (PBN);

dihydroquinoline derivatives such as, for example, 2,2,4-trimethyldihydroquinoline, 6-ethoxy-2,2,4-trimethyl-1,2-dihydroquinoline (ETMQ);

imidazole derivatives such as, for example, mercaptobenzimidazole (MBI), 4-methylmercaptobenzimidazole (MMBI), or zinc salts thereof;

phenol derivatives such as, for example, 2,6-di-t-butyl-p-cresol (BHT), 2,4-dimethyl-6-t-butylphenol, 2,4-dimethyl-6-(α-methylcyclohexyl)phenol, 2,6-di-t-butyl-4-methoxymethylphenol, 2,2′-methylene-bis(4-methyl-6-t-butylphenol) (BPH), 2,2′-methylene-bis(4-methyl-6-cyclohexyl)phenol (CPH), 2,2′-isobutylidene-bis(4,6-dimethylphenol) (IBPH), 2,2′-methylene-bis(4-ethyl-6-t-butylphenol), 4,4′-thio-bis(3-methyl-6-t-butylphenol), 1,1,3-tris(2′-methyl-4′-hydroxy-5′-t-butylphenyl)butane;

antioxidants derived from the polymerization of compounds such as, for example, dimethyl 5-(3,5-di-t-butyl-4-hydroxybenzenepropanamido)iso-phthalate (BPI), dimethyl 5-(3,5-di-t-butyl-4-hydroxybenzamido)isophthalate (BI), diethyl 2-(3,5-di-t-butyl-4-hydroxybenzenepropanamido)-succinate (BPS);

phenol-phenylnitrone antioxidants;

siloxanediols, phosphites, dithiocarbamates, diimides;

waxes such as, for example, paraffin waxes.

Specific examples of coupling agents (a8), in particular coupling agents for silica such as hydrolysable silanes containing sulphur, which may be used in the present invention include: 3,3′-bis(trimethoxysilylpropyl)disulphide, 3,3,-bis(tri-ethoxysilylpropyl)tetrasulphide (X50S® from Degussa), 3,3,-bis(triethoxysilylpropyl)octasulphide, 3,3,-bis-(trimethoxysilylpropyl)tetrasulphide, 2,2′-bis(tri-ethoxysilylethyl)tetrasulphide, 3,3′-bis(trimethoxy-silylpropyl)trisulphide, 3,3′-bis(triethoxysilyl-propyl)trisulphide, 3,3′-bis(tributoxysilylpropyl)disulphide, 3,3′-bis(trimethoxysilylpropyl)hexasulphide, 3,3′-bis(trimethoxysilylpropyl)octasulphide; 3,3′-bis(trioctoxysilylpropyl)tetrasulphide, 3,3′-bis(trihexoxysilylpropyl)disulphide, 3,3′-bis(tri-2-ethyl-hexoxysilylpropyl)trisulphide, 3,3′-bis(triisooctoxy-silylpropyl)tetrasulphide, 3,3′-bis(tri-t-butoxysilyl-propyl)disulphide, 2,2′-bis(methoxydiethoxysilylethyl)tetrasulphide, 2,2′-bis(tripropoxysilylethyl)pentasulphide, 3,3′-bis(tricyclohexoxysilylpropyl)tetrasulphide, 3,3′-bis(tricyclopentoxysilylpropyl)trisulphide, 2,2′-bis(tri-2-methylcyclohexoxysilylethyl)tetrasulphide, bis (trimethoxysilylmethyl) tetrasulphide, 3-methoxyethdxypropoxysilyl-3′-diethoxybutoxysilyl-propyltetrasulphide, 2,2′-bis(dimethylmethoxysilyl-ethyl)disulphide, 2,2′-bis(dimethyl-sbutoxysilyl-ethyl)trisulphide, 3,3′-bis(methylbutylethoxysilyl-propyl)tetrasulphide, 3,3′-bis(di-t-butylmethoxysilyl-propyl)tetrasulphide; 2,2′-bis(phenylmethylmethoxy-silylethyl)trisulphide, 3,3′-bis(diphenylisopropoxy-silylpropyl)tetrasulphide, 3,3′-bis(diphenylcyclo-hexoxysilylpropyl)disulphide, 3,3′-bis(dimethylethyl-mercaptosilylpropyl)tetrasulphide, 2,2′-bis(methyl-dimethoxysilylethyl)trisulphide, 2,2′-bis(methylethoxy-propoxysilylethyl)tetrasulphide, 3,3′-bis(diethyl-methoxysilylpropyl)tetrasulphide, 3,3′-bis(ethyl-di-s-butoxysilylpropyl)disulphide, 3,3′-bis(propyldiethoxy-silylpropyl)disulphide, 3,3′-bis(butyldimethoxysilyl-propyl)trisulphide, 3,3′-bis(phenyldimethoxy-silylpropyl)tetrasulphide, 3-phenylethoxybutoxysilyl-3′-trimethoxysilylpropyltetrasulphide, 4,4′-bis(tri-methoxysilylbutyl)tetrasulphide, 6,6′-bis(triethoxy-silylhexyl)tetrasulphide, 12,12′-bis(triisopropoxy-silyldodecyl)disulphide, 18,18′-bis(trimethoxysilyl-octadecyl)tetrasulphide, 18,18′-bis(tripropoxysilyl-octadecenyl)tetrasulphide, 4,4′-bis(trimethoxysilyl-buten-2-yl)tetrasulphide, 4,4′-bis(trimethoxysilyl-cyclohexylene)tetrasulphide, 5,5,-bis(dimethoxymethyl-silylpentyl)trisulphide, 3,3′-bis(trimethoxysilyl-2-methylpropyl)tetrasulphide, 3,3′-bis(dimethoxyphenyl-silyl-2-methylpropyl) disulphide.

Specific examples of condensation catalysts (a9) which may be used in the present invention include:

metals carboxylates such as tin, zinc, zirconium, iron, lead, cobalt, barium, calcium, manganese and the like, such as, for example, dibutyltin dilaurate, dibutyltin diacetate, dioctyltin dilaurate, stannous acetate, stannous caprylate, lead naphthenate, zinc caprylate, zinc naphthenate, cobalt naphthenate, iron octanoate, iron 2-ethylhexanoate, and the like;

arylsulphonic acids or derivatives thereof such as, for example: toluenesulphonic acid, p-dodecylbenzenesulphonic acid, tetrapropyl-benzenesulphonic acid, acetyl p-dodecylbenzene-sulphonate, 1-naphthalenesulphonic acid, 2-naphthalenesulphonic acid, acetylmethyl sulphonate, acetyl p-toluenesulphonate, and the like;

amines and alkanolamines such as, for example, ethylamine, dibutylamine, hexylamine, pyridine, dimethylethanolamine, and the like;

strong inorganic acids or bases such as, for example, sodium hydroxide, potassium hydroxide, sulphuric acid, hydrochloric acid, and the like;

organic acids such as, for example, acetic acid, stearic acid, maleic acid, and the like;

blocked acids such as, for example, stearic anhydride, benzoic anhydride, and the like;

zeolites modified by reaction with at least one carboxyc acid and/or sulphonic acid such as, for example, toluenesulphonic acid, α,β-naphthalenesulphonic acid, and the like.

With reference to the copolymer (i), the term aliphatic α-olefin means an olefin of formula CH₂═CH—R, in which R represents a linear or branched alkyl group containing from 1 to 12 carbon atoms. Preferably, the aliphatic α-olefin is chosen from propylene, 1-butene, isobutyIene, 1-pentene, 4-methyl-1-pentene, 1-hexene, 1-octene, 1-dodecene, or mixtures thereof. 1-Octene is particularly preferred.

With reference to the copolymer (i), the term aromatic α-olefin means an olefin of formula:

CH₂═CH—(R₁R₂C)ₓ—C₆H_{5-y}(R₃)_{y}

in which R₁, R₂ and R₃, which may be identical to or different, from each other, represent hydrogen or a linear or branched alkyl group containing from 1 to 8 carbon atoms; or R₃, different from R₁ and R₂, represents an alkoxy group, a carboxyl group, an acyloxy group, said acyloxy group optionally being substituted with alkyl groups containing from 1 to 8 carbon atoms or hydroxyl groups or halogen atoms; x is 0 or an integer between 1 and 5 inclusive; y is 0, 1 or 2. Preferably, the aromatic x-olef in is chosen from styrene, α-methylstyrene, or mixtures thereof. Styrene is particularly preferred.

According to one preferred embodiment, said copolymer (i) is characterized by a high regioregularity in the sequence of monomer units. In particular, said copolymer contains an amount of —CH₂— groups in —(CH₂)ₙ— sequences, in which n is an even integer, which is generally less than 5 mol % and preferably less than 1 mol % relative to total amount of —CH₂— groups. The amount of —(CH₂)ₙ— sequences may be determined according to conventional techiques, by means of ¹³C-NMR analysis. According to another preferred embodiment, said copolymer (i) is characterized by a composition distribution index of greater than 45%, said index being defined as the weight percentage of copolymer molecules with an α-olefin content within 50% of the average total molar content of α-olefin.

The composition distribution index provides a measure of the distribution of the aliphatic or aromatic α-olefin among the copolymer molecules, and may be determined by means of Temperature Rising Elution Fractionation techniques as described, for example, in U.S. Pat. No. 5,008,204, or in Wild et al. J. Poly. Sci. Poly, Phys. ed., Vol. 20, p. 441 (1982).

With reference to the copolymer (i), the term polyene means a diene, a triene or a tetraene, which may be conjugated or non-conjugated. When a diene comonomer is present, said comonomer generally contains from 4 to 20 carbon atoms and is preferably chosen from: linear conjugated or non-conjugated diolefins such as, for example, 1,3-butadiene, 1,4-hexadiene, 1,6-octadiene, and the like; monocyclic or polycyclic dienes such as, for example, 1,4-cyclohexadiene, 5-ethylidene-2-norbornene, 5-methylene-2-norbornene, vinylnorbornene, or mixtures thereof. When a triene or tetraene comonomer is present, said comonomer generally contains from 9 to 30 carbon atoms and is preferably chosen from trienes and tetraenes containing a vinyl group in the molecule or a 5-norbornen-2-yl group in the molecule. Specific examples of triene or tetraene comonomers which may be used in the present invention include: 6,10-dimethyl-1,5,9-undecatriene, 5,9-dimethyl-1,4,8-decatriene, 6,9-dimethyl-1,5,8-decatriene, 6,8,9-trimethyl-1,6,8-decatriene, 6,10,14-trimethyl-1,5,9,13-pentadecatetraene, or mixtures thereof. The polyene is preferably a diene. According to another preferred embodiment, said copolymer (i) consists of copolymers of ethylene and of at least one C₃-C₁₂ aliphatic α-olefin, preferably 1-octene, or, aromatic α-olefin, preferably styrene, and optionally a polyene, preferably a diene, characterized by:

a density of between 0.86 g/cm³ and 0.93 g/cm³;

a Mooney viscosity ML (1+4) at 125° C., measured according to ASTM standard D1646-00, generally of greater than 5, preferably between 8 and 40;

a Melt Flow Index (MFI), measured according to ASTM standard D1238-00, of between 0.1 g/10 min and 35 g/10 min, preferably between 1 g/10 min and 20 g/10 min;

a melting temperature (Tₘ) of between 50° C. and 120° C., preferably between 55° C. and 110° C.;

a melting enthalpy (ΔHₘ) of between 30 J/g and 150 J/g, preferably between 34 J/g and 130 J/g.

The copolymer (i) generally has the following composition: 50 mol %-97 mol %, preferably 60 mol %-95 mol %, of ethylene; 3 mol %-50 mol %, preferably 5 mol %-50 mol %, of an aliphatic or aromatic α-olefin; 0 mol %-5 mol %, preferably 0 mol %-2 mol %, of a polyene.

The copolymer (i) may be obtained by copolymerization of ethylene with an aliphatic or aromatic α-olefin, and optionally a polyene, in the presence of a “single-site” catalyst, for example a metallocene catalyst, as described, for example, in patents U.S. Pat. No. 5,246,783 and U.S. Pat. No. 5,272,236. The metallocenes used in the polymerization of olefins are coordination complexes between a transition metal, usually from group IV, in particular titanium, zirconium or hafnium, and two cyclopentadienyl ligands, which are optionally substituted, used in combination with a co-catalyst, for example an aluminoxane, preferably a methylaluminoxane, or a boron compound (see, for example, J.M.S.—Rev. Macromol. Chem. Phys., C34(3), 493-514 (1994); J. Organometallic Chemistry, 479 (1994), 1-29, patents U.S. Pat. No. 5,414,040, U.S. Pat. No. 5,229,478, or patent applications WO 93/19107, EP 889 091 and EP 632 065, the abovementioned patents U.S. Pat. No. 5,246,783 and U.S. Pat. No. 5,272,236). Catalysts that are suitable for obtaining the copolymer (i) according to the present invention also include the “constrained geometry catalysts” described, for example, in patents EP 416 815, EP 418 044 and U.S. Pat. No. 5,703,187.

Examples of copolymers (i) which may be used in the present invention and which are currently commercially available include the products Engage® from DuPont-Dow Elastomer and Exact® from Exxon Chemical.

The copolymer (i) may optionally contain functional groups chosen from: carboxylic groups, anhydride groups, ester groups, silane groups, epoxide groups. The amount of functional groups present in the polymer is generally between 0.05 and 50 parts by weight, preferably between 0.1 and 10 parts by weight, relative to 100 parts by weight of copolymer (i).

The functional groups may be introduced during the production of the copolymer (i), by copolymerization with corresponding functionalized monomers containing at least one ethylenic unsaturation, or by subsequent modification of the copolymer (i) by grafting the abovementioned functionalized monomers in the presence of a free-radical initiator (in particular an organic peroxide).

Alternatively, the functional groups may be introduced by reacting pre-existing groups on the copolymer (i) with a suitable reagent, for example by means of an epoxidation reaction of a diene polymer containing double bonds along the main chain and/or as side groups with a peracid (for example m-chloroperbenzoic acid or peracetic acid) or with hydrogen peroxide in the presence of a carboxylic acidor a derivative thereof.

Functionalized monomers which may be used, for example, include: silanes containing at least one ethylenic unsaturation; epoxides containing at least one ethylenic unsaturation; monocarboxylic or, preferably, dicarboxylic acids containing at least one ethylenic unsatuiration, or derivatives thereof, in particular anhydrides or esters.

Examples of silanes containing at least one ethylenic unsaturation include: γ-methacryloxypropyltrimethoxysilane, allyltrimethoxysilane, allyltriethoxysilane, allylmethyldimethoxysilane, allylmethyldiethoxysilane, vinyltris(2-methoxyethoxy) silane, vinyltrimethoxysilane, vinylmethyldimethoxysilane, vinyltriethoxysilane, and the like, or mixtures thereof.

Examples of epoxides containing at least one ethylenic unsaturation include: glycidyl acrylate, glycidyl methacrylate, itaconic acid monoglycidyl ester, maleic acid glycidyl ester, vinyl glycidyl ether, allyl glycidyl ether, and the like, or mixtures thereof.

Examples of monocarboxylic or dicarboxylic acids containing at least one ethylenic unsaturation, or derivatives thereof, include: maleic acid, maleic anhydride, fumaric acid, citraconic acid, itaconic acid, acrylic acid, methacrylic acid, and the like, and anhydrides or esters derived therefrom, or mixtures thereof. Maleic anhydride is particularly preferred.

As mentioned above, the thermoplastic binder (i) may also comprise (ii) a polymer obtained by a metathesis reaction of a cycloalkene. According to one preferred embodiment, the polymer (ii) is a polyoctenamer. Said polymer (ii) preferably has the following characteristics:

a percentage of double bonds in trans configuration, determined by infrared (IR) spectrometry, of at least 60 mol %, preferably between 75 mol % and 95 mol %;

a Mooney viscosity ML (1+4) at 125° C., measured according to ASTM standard D1646-00, of between 2 and 20, preferably between 5 and 15;

a melting point, measured by DSC (Differential Scanning Calorimetry) of between 25° C. and 80° C., preferably between 40° C. and 60° C.;

a glass transition temperature (Tg), measured according to DIN standard 53445, of between −90° C. and −50° C., preferably between −80° C. and −60° C.

The polymer (ii) may be obtained according to conventional techniques, by a metathesis reaction, in solution, of cycloalkene such as, for example, cyclopentene, cyclooctene, cyclododecene, in the presence of a mixture of catalysts based on metals compounds belonging to subgroups 5-7 and of metals belonging to the main groups 1-4 of the Periodic Table of the Elements (for example the tungsten hexachloride/aluminium ethyl dichloride catalytic system). It should be pointed out that the references to the Periodic Table of the Elements refer to the version of the table published in “Handbook of Chemistry and Physics”, pub CRC, 1987, using the IUPAC system as regards groups and subgroups.

Further details regarding the preparation of the polymer (ii) are described, for example, by Scott, Calderon, Ofstead, Judy and Ward in “Rubber Chem. and Tech.”, 44, (1971) and in the references cited therein, and in patents U.S. Pat. No. 3,816,358 and U.S. Pat. No. 4,153,772.

Examples of polymers (ii) which may be used in the present invention and which are currently commercially available include the Vestenamer® products from Degussa-Hüls.

As stated above, the thermoplastic binder (i) may also comprise (iii) a copolymer of ethylene with at least one ester containing an ethylenic unsaturation. According to one preferred embodiment, the copolymer (iii) is, a copolymer of ethylene with at least one ester containing an ethylenic unsaturation, chosen from: alkyl acrylates, alkyl methacrylates and vinyl carboxylatest, in which the linear or branched alkyl group may contain from 1 to 8, preferably from 1 to 4 carbon atoms, while the linear or branched carboxylic group may contain from 2 to 8, preferably from 2 to 5 carbon atoms. Said ester may be present in the copolymer in an amount of between 5% and 50% by weight, preferably between 15% and 40% by weight. Examples of acrylates and methacrylates include: ethyl acrylate, methyl acrylate, methyl methacrylate, t-butyl acrylate, n-butyl acrylate, n-butyl methacrylate, 2-ethylhexyl acrylate. Examples of vinyl carboxylates include: vinyl acetate, vinyl propionate, vinyl butanoate.

Specific examples of copolymers (iii) which may be used in the present invention include: ethylene/vinyl acetate (EVA), ethylene/ethyl acrylate (EEA), ethylene/butyl acrylate (EBA). The ethylene/vinyl acetate (EVA) copolymer is preferred.

Said copolymers (iii) may be prepared according to conventional techniques, generally by high-pressure polymerization.

For the purpose of improving the impact; strength properties of the products in subdivided form of the present invention, said products, as mentioned above, may also comprise an elastomeric polymer (iv).

According to one preferred embodiment, the elastomeric polymer (iv) may be chosen from the diene elastomeric polymers commonly used in sulphur-crosslinkable elastomeric compositions, in particular from elastomeric polymers or copolymers containing an unsaturated chain, with a glass transition temperature generally of less than 20° C., preferably between 0° C. and −90° C. These polymers or copolymers may be of natural origin or may be obtained by solution polymerization or emulsion polymerization of one or more conjugated diolefins, optionally mixed with one or more monovinylarenes in amounts generally not greater than 50% by weight.

The conjugated diolefins generally contain from 4 to 12, preferably from 4 to 8 carbon atoms, and may be chosen from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-Butadiene and isoprene are particularly preferred.

Monovinylarenes which may optionally be used as comonomers generally contain from 8 to 20, preferably from 8 to 12 carbon atoms, and may be chosen, for example, from: styrene; 1-vinylnaphthalene; 2-vinylnaphthalene; various alkyl, cycloalkyl, aryl, alkylaryl or arylalkyl derivatives of styrene, such as, for example: α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Preferably, the elastomeric polymer (iv) which may be used according to the present invention may be chosen from: cis-1,4-,polyisoprene (natural or synthetic, preferably natural rubber), 3,4-polyisoprene, polychloroprene, optionally halogenated isoprene/isobutene copolymers, 1,3-butadiene/acrylonitrile copolymers, styrene/1,3-butadiene copolymers, styrenelisoprene copolymers, styrene/isoprene/1,3-butadiene copolymers; or mixtures thereof.

According to a further preferred embodiment, the elastomeric polymer (iv) may be chosen from elastomeric polymers of one or more monoolefins with an olefinic comonomer or derivatives thereof, said elastomeric polymer (iv) being characterized by a melting enthalpy (ΔHₘ) of less than 15 J/g. The monoolefins may be chosen from: ethylene and α-olefins generally containing from 3 to 12 carbon atoms, such as, for example, propylene, 1-butene, 1-pentene, 1-hexene, 1-octene, or mixtures thereof. The following are preferred: copolymers of ethylene and of an α-olefin, and optionally of a diene; isobutene homopolymers or copolymers thereof with smaller amounts of a diene, which are optionally at least partially halogenated. The diene which may be present generally contains from 4 to 20 carbon atoms and is preferably chosen from: 1,3-butadiene, isoprene, 1,4-hexadiene, 1,4-cyclohexadiene, 5-ethylidene-2-norbornene; 5-methylene-2-norbornene, vinylnorbornene, or mixtures thereof.

Among these, the dienes that are particularly preferred include: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

For the purpose of improving the mechanical strength of the products in subdivided form of the present invention, said products, as mentioned above, may also comprise a reinforcing filler (v).

According to one preferred embodiment, the reinforcing filler (v) is chosen from carbon black or from the so-called white fillers such as, for example, silica, alumina, aluminosilicates, calcium carbonate, kaolin, titanium dioxide, or mixtures thereof.

For the purpose of promoting the dispersion of the additive (a) in the thermoplastic binder (b), the products in subdivided form of the present invention, as mentioned above, may also comprise plasticizer (vi).

It should be pointed out that the plasticizer (vi) is, in some cases, already present in the additive (a) such as, for example, in the case of the sulphur which is commonly commercialized as a dispersion in an oil (referred to as sulphur oleate) since, in the absence of oil, sulphur presents either handling and processability problems due to its tendency to form large aggregates, or hazard problems due to its flammability.

According to one preferred embodiment, the plasticizer (vi) is chosen from mineral oils such as, for example, paraffinic oils, naphthenic oils, aromatic oils; vegetable oils; or mixtures thereof. Paraffinic oils are particularly preferred. The further presence of the abovementioned compounds (iv), (v) and (vi) also makes it easier to convey and disperse the additive (a) in the crosslinkable elastomeric compositions into which the product in subdivided form is added.

For the purpose of identifying the various types of products in subdivided form of the present invention on the basis of the additive (a) present, said products may also comprise at least one pigment chosen from the organic and inorganic pigments usually used in elastomeric compositions. The amount of pigment used is such that it gives the product in subdivided form a sufficient coloration.

The products in subdivided form according to the present invention may be obtained by mixing the various components, followed by granulation by means of various processes. Said mixing may be carried out, for example, using an open mill or an internal mixer of the type with tangential rotors (Banbury) or with interlocking rotors (Intermix), or in continuous mixers such as a Ko-Kneader mixer (Buss), or by extrusion using co-rotating or counter-rotating twin-screw extruders or using single-screw extruders. The subsequent granulation may be carried out, for example, by grinding the mixture obtained or, in the case of extrusion, by means of a uniform chopping of the extruded material in the form of “spaghetti” (for example using a chopper).

As mentioned above, the process for preparing a crosslinkable elastomeric composition according to the present invention may be carried out in continuous or batchwise mode.

When said process is carried out in continuous mode, the mixing of the polymer base with the other components and with the product in subdivided form is carried out, for example, in continuous mixers such as a Ko-Kneader mixer (Buss) or in co-rotating or counter-rotating twin-screw extruders or in single-screw extruders.

When the process is carried out in batchwise mode, the mixing of the polymer base with the other components and with the products in subdivided form is carried out, for example, using an open internal mixer such as an open mill, or an internal mixer of the type with tangential- rotors (Banbury) or with interlocking rotors (Intermix).

During the mixing, the temperature is kept below a predetermined value so as to avoid premature crosslinking of the composition. To this end, the temperature is generally kept below 170° C., preferably below 150° C., even more preferably below 120° C. As regards the mixing time, this may vary within a wide range, depending mainly on the specific composition of the mixture, on the presence of reinforcing fillers and on the type of mixer used. In general, a mixing time of more than 90 seconds, preferably between 3 minutes and 35 minutes is sufficient to obtain a homogeneous composition.

As mentioned above, the polymer base comprises at least one elastomeric polymer, at least one reinforcing filler and at least one plasticizer.

Said elastomeric polymer is generally chosen from natural and synthetic elastomers, optionally oil-extended, such, as, for example, natural rubber; butyl rubber; polybutadiene, polyisoprene; styrene/butadiene copolymers; butadiene/isoprene copolymers; styrene/isoprene copolymers; nitrile rubbers; ethylene/propylene copolymers, terpolymers of ethylene, of propylene and of non-conjugated dienes such as 5-ethylidene-2-norbornene, 1,4-hexadiene, cyclooctadiene, dicyclopentadiene, or mixtures thereof.

Said reinforcing filler is generally chosen from carbon black or from the so-called white fillers such as, for example, silica, alumina, aluminosilicates, calcium carbonate$ kaolin, titanium dioxide, or mixtures thereof.

Said plasticizer is generally chosen from mineral oils such as, for example, paraffinic oils, naphthenic oils, aromatic oils; vegetable oils; or mixtures thereof.

The present invention will be further illustrated hereinbelow by means of a number of preparation examples given purely as a guide and with no limitation thereof.

### EXAMPLE 1

The products below were loaded into a co-rotating twin-screw extruder (screw diameter: 30 mm; L/D ratio: 54 mm), via a side hopper:

ethylene/1-octene copolymer obtained by metallocene catalysis (Engage® 8150 from Du Pont-Dow Elastomers, having the following characteristics: ethylene/1-octene weight ratio=75/25; d=0.868 g/cm³; MFI=0.5 g/10 min; ΔHₘ=34.8 J/g; Tₘ=59.2° C.);

polyoctenamer (Vestenamer® 8012 from Degussa-Hüls, having the following characteristics: percentage content of double bonds in trans configuration equal to 80 mol %; Mooney viscosity ML (1+4) at 125° C. of less than 10; melting point equal to 54° C.; glass transition temperature (Tg) equal to −75° C.); and

zinc oxide powder.

The melting enthaipy (ΔHₘ) of the ethylene/1-octene copolymer mentioned above was measured by differential scanning calorimetry using a Mettler machine, working under the following conditions. A sample (about 10 mg) of the ethylene copolymer to be analysed was cooled to −25° C. and then heated to 200° C. at a scanning speed equal to 20° C./min. The sample was held at 200° C. for 5 minutes and then cooled to 0° C. at a scanning speed equal to 20° C./min. After 5 minutes at 0° C., the sample was again heated to 200° C. at a scanning speed equal to 10° C./min. The melting enthalpy (ΔHₘ) and melting temperature (Tₘ) values reported refer to this second heating phase (second melting values) and correspond, respectively, to the area subtended by the melting peaks between 0° C. and 200° C. and to the temperature value corresponding to the maximum of these peaks.

The abovementioned products were fed in at the following feed rates:

ethylene/1-octene copolymer: 0.75 kg/h;

polyoctenamer: 0.75 kg/h;

zinc oxide powder: 8.5 kg/h.

The abovementioned mixture was extruded through a die 3.5 mm in diameter, at a screw spin speed of 195 rpm and a constant temperature profile of 205° C. The extruded material in the form of “spaghetti” was cooled in a water bath, dried in a stream of air and chopped using a chopper, to give granules having the following dimensions: diameter 2 mm, length 3 mm. Granules thus obtained were free of powder.

### EXAMPLE 2

Using the same extruder as in Example 1, the products below were loaded via a side hopper:

paraffin wax; and

carbon black (N660);

while the product below was loaded via the main hopper:

ethylene/1-octene copolymer obtained by metallocene catalysis (Engage® 8200 from Du Pont-Dow Elastomers, having the following characteristics: ethylene/1-octene weight ratio=76/24; d=0.870 g/cm³; MFI=0.5 g/10 min; ΔHₘ=24 J/g; Tₘ=60° C.).

The melting enthalpy (AHm) of the ethylene/1-octene copolymer given above was measured as described in Example 1.

The abovementioned products were fed in at the following feed rates:

paraffin wax: 4.66 kg/h;

carbon black: 2.34 kg/h;

ethylene/1-octene copolymer: 3 kg/h.

The abovementioned mixture was extruded through a die 3.5 mm in diameter, with a screw spin speed of 250 rpm and a constant temperature profile of 60° C. The extruded material in the form of “spaghetti” was cooled in a water bath, dried in a stream of air and chopped using a chopper, to give granules having the following dimensions: diameter 2 mm, length 3 mm. The granules thus obtained were free of dusts.

### EXAMPLE 3

Using the same extruder as in Example 1, the products below were loaded via a side hopper:

ethylene/1-octene copolymer obtained by metallocene catalysis (Engage® 8200 from Du Pont-Dow Elastomers, having the following characteristics: ethylene/1-octene weight ratio=76/24; d=0.870 g/cm³; MFI=0.5 g/10 min; ΔHₘ=24 J/g; Tₘ=60° C.);

mixture of polymeric sulphur and paraffinic oil (weight ratio: 2:1) containing 5% Zeosil® 1165 silica from Rhodia Silica).

The melting enthalpy (ΔHₘ) of the ethylene/1-octene copolymer given above was measured as described in Example 1.

The abovementioned products were fed in at the following feed rates:

ethylene/1-octene copolymer: 1 kg/h;

sulphur mixture: 9 kg/h.

The abovementioned mixture was extruded through a die 3.5 mm in diameter, at a screw spin speed of 200 rpm and at a constant temperature profile of 68° C. The extruded material in the form of “spaghetti” was cooled in a water bath, dried in a stream of air and chopped using a chopper, to give granules having the following dimensions: diameter 2 mm, length 3 mm. The granules thus obtained were free of dusts.

### EXAMPLE 4

Using the same extruder as in Example 1, the products below were loaded via a side hopper:

ethylene/1-octene copolymer obtained by metallocene catalysis (Engage® 8200 from Du Pont-Dow Elastomers, having the following characteristics: ethylene/1-octene weight ratio=76/24; d=0.870 g/cm³; MFI=0.5 g/10 min; ΔHₘ=24 J/g; Tₘ=60° C.); and

N-cyclohexyl-2-benzothiazyl sulphenamide (CBS-Santocure® from Monsanto).

The melting enthalpy (ΔHₘ) of the ethylene/1-octene copolymer given above was measured as described in Example 1.

The abovementioned products were fed in at the following feed rates:

ethylene/1-octene copolymer: 2.4 kg/h;

N-cyclohexyl-2-benzothiazyl sulphenamide: 5.6 kg/h.

The abovementioned mixture was extruded through a die 3.5 mm in diameter, at a screw spin speed of 195 rpm and at a constant temperature profile of 95° C. The extruded material in the form of “spaghetti” was cooled in a water bath, dried in a stream of air and chopped using a chopper, to give granules having the following dimensions: diameter 2 mm, length 3 mm. Granules thus obtained were free of dusts.

### EXAMPLE 5

Using the same extruder as in Example 1, the products below were loaded via the main hopper:

ethylene/1-octene copolymer obtained by metallocene catalysis (Engage® 8200 from Du Pont-Dow Elastomers, having the following characteristics: ethylene/1-octene weight ratio=76/24; d=0.870 g/cm³; MFI=0.5 g/10 min; ΔHₘ=24 J/g; Tₘ=60° C.); and

polyoctenamer (Vestenamer® 8012 from Degussa-Hüls, having the following characteristics: percentage content of double bonds in trans configuration equal to 80%; Mooney viscosity ML (1+4) at 125° C., of less than 10; melting point equal to 54° C.; glass transition temperature (Tg) equal to −75° C.);

while the products below were loaded via a side hopper:

poly-α-methylstyrene resin (Kristalex® from Hercules); and

paraffin wax.

The melting enthalpy (ΔHₘ) of the ethylene/1-octene copolymer given above was measured as described in Example 1.

The abovementioned products were fed in at the following feed rates:

ethylene/1-octene copolymer: 1.5 kg/h;

polyoctenamer: 1.5 kg/h;

poly-α-methylstyrene resin: 7 kg/h;

paraffin wax: 7 kg/h.

The abovementioned mixture was extruded through a die 3.5 mm in diameter, at a screw spin speed of 320 rpm and at a constant temperature profile of 70° C. The extruded material in the form of “spaghetti” was cooled in a water bath, dried in a stream of air and chopped using a chopper, to give granules having the following dimensions: diameter 2 mm, length 3 mm. The granules thus obtained were free of dusts.

### EXAMPLE 6

Using the same extruder as in Example 1, the products below were loaded via a side hopper:

ethylene/1-octene copolymer obtained by metallocene catalysis (Engage® 8150 from Du Pont-Dow Elastomers, having the following characteristics: ethylene/1-octene weight ratio=75/25 (7.6 mol % of 1-octene); d=0.868 g/cm³; MFI=0.5 g/10 min; ΔHₘ=34.8; Tₘ=59.2° C.);

zinc stearate;

stearic acid; and

carbonblack (N660).

The melting enthalpy (ΔHₘ) of the ethylene/1-octene copolymer given above was measured as described in Example 1.

The abovementioned products were fed in at the following feed rates:

ethylene/1-octene copolymer: 0.5 kg/h;

zinc stearate: 9 kg/h;

stearic acid: 9 kg/h;

carbon black: 9 kg/h.

The abovementioned mixture was extruded through a die 3.5 mm in diameter, at a screw spin speed of 250 rpm and at a constant temperature profile of 85° C. The extruded material in the form of “spaghetti” was cooled in a water bath, dried in a stream of air and chopped using a chopper, to give granules having the following dimensions: diameter 2 mm, length 3 mm. The granules thus obtained were free of dusts.

### EXAMPLE 7

### Hardness Tests

The granules of Examples 1-6 were subjected to Shore A and Shore D hardness tests. For this purpose, samples of the granules (about 6 g each) were compression-moulded in a circular mould, working under the following conditions:

temperature: 90° C.;

pressure: 19,090 Pa;

time: 3 minutes;

to give compact discs with a diameter of 5 cm and a thickness of 0.5 cm.

The abovementioned discs were tested using a Zwick 3100 durometer, working according to ASTM standard D2240-00. The discs were subjected to measurement at six different points on the upper circular surface and the results obtained, which are the average of the six measurements taken on each disc, are given in Table 1.

TABLE 1

| EXAMPLE | Shore A | Shore D |
|---|---|---|
| 1 | — | 53.0 |
| 2 | — | 37.0 |
| 3 | 59.8 | 11.8 |
| 4 | — | 29.3 |
| 5 | — | 45.0 |
| 6 | — | 23.8 |

### EXAMPLE 8

### Flowability Tests

The granules of Examples 1-6 were subjected to flowability tests. For this purpose, a funnel consisting of a first portion of frustoconical shape (hopper) followed by a second portion defining an outlet channel from said first portion, was used. Said funnel had the following characteristics:

hopper angle: 60°;

length of the outlet channel: 10 cm;

initial diameter of the outlet channel: 2.8 cm;

final diameter of the outlet channel: 1.8 cm.

The term “hopper angle” means the angle between a directrix of the frustoconical surface of said hopper and the longitudinal axis of said outlet channel.

The granules (200 ml) were loaded into said funnel and the time required for all the granules to leave via said outlet channel was measured: at time 0 the granules were allowed to flow freely, the timer being stopped when the last granule left the outlet channel. The data obtained are given in Table 2 and are the average of six tests.

TABLE 2

| EXAMPLE | Time (sec) |
|---|---|
| 1 | 5.80 |
| 2 | 6.55 |
| 3 | 5.37 |
| 4 | 5.38 |
| 5 | 5.08 |
| 6 | 6.96 |

### EXAMPLE 9

### Mechanical Strength Tests

The granules of Examples 1, 3, 4 and 6 were subjected to mechanical strength tests. For this purpose, a Retsch S100 planetary mill containing steel balls with a diameter equal to 30 mm (ball weight: 108.8 g) was used, working under the following conditions:

volume of the cylindrical chamber: 250 ml;

diameter of the cylindrical chamber: 7.5 cm;

amount of granules: 50 ml;

spin speed: 500 rpm;

grinding time: 3 min.

At the end of the grinding, the size distribution of the granules are measured, working according to ISO standard 1435 (1981) and using a sieve with a mesh. size of 2 mm. Table 3 gives the weight percentage of granules retained on the sieve.

TABLE 3

| EXAMPLE | % by weight |
|---|---|
| 1 | 99.9 |
| 3 | 99.8 |
| 4 | 99.7 |
| 6 | 98.7 |

1. Product in subdivided form comprising:
(a) from 40% to 95% by weight relative to the total weight of said product in subdivided form of at least one additive for crosslinkable elastomeric compositions; and
(b) a thermoplastic binder comprising at least (i) one copolymer of ethylene with at least one aliphatic or aromatic α-olefin, and optionally a polyene, said copolymer being characterized by a molecular weight distribution (MWD) index of less than 5 and a melting enthalpy (ΔHₘ) of at least 30 J/g.

2. Product in subdivided form according to claim 1, in which the additive (a) is present in an amount of between 50% and 90% by weight relative to the total weight of said product in subdivided form.

3. Product in subdivided form according to claim 2, in which the additive (a) is present in an amount of between 70% and 80% by weight relative to the total weight of said product in subdivided form.

4. Product in subdivided form according to any one of the preceding claims, in which the molecular weight distribution index is between 1.5 and 3.5.

5. Product in subdivided form according to any one of the preceding claims, in which the melting enthalpy (ΔHₘ) is between 34 J/g and 150 J/g.

6. Product in subdivided form according to any one of the preceding claims, in which the copolymer (i) is present in an amount of between 20% and 100% by weight relative to the weight of said thermoplastic binder (b).

7. Product in subdivided form according to claim 6, in which the copolymer (i) is present in an amount of between 35% and 100% by weight relative to the weight of said thermoplastic binder (b).

8. Product in subdivided form according to any one of the preceding claims, in which the thermoplastic binder (b) comprises from 0% to 80% by weight, relative to the weight of said thermoplastic binder (b), of at least (ii) one polymer obtained by a metathesis reaction of a cycloalkene.

9. Product in subdivided form according to claim 8, in which the thermoplastic binder (b) comprises from 0% to 65% by weight, relative to the weight of said thermoplastic binder (b), of at least (ii) one polymer obtained by a metathesis reaction of a cycloalkene.

10. Product in subdivided form according to any one of the preceding claims, in which the thermoplastic binder (b) comprises from 0% to 80% by weight, relative to the weight of said thermoplastic binder (b), of at least (iii) one copolymer of ethylene with at least one, ester containing an ethylenic unsaturation.

11. Product in subdivided form according to claim 10, in which the thermoplastic binder (b) comprises from 0% to 65% by weight, relative to the weight of said thermoplastic binder (b), of at least (iii) one copolymer of ethylene with at least one ester containing an ethylenic unsaturation.

12. Product in subdivided form according to any one of the preceding claims, comprising from 0% to 40% by weight, relative to the weight of the additive (a), of at least (iv) one elastomeric polymer.

13. Product in subdivided form according to claim 12, comprising from 10% to 20% by weight, relative to the weight of the additive (a), of at least (iv) one elastomeric polymer.

14. Product in subdivided form according to any one of the preceding claims, comprising from 0% to 60% by weight, relative to the weight of the additive (a), of at least (v) one reinforcing filler.

15. Product in subdivided form according to claim 14, comprising from 5% to 40% by weight, relative to the weight of the additive (a), of at least (v) one reinforcing filler.

16. Product in subdivided form according to any one of the preceding claims, comprising from 0% to 40% by weight, relative to the weight of the additive (a), of at least (vi) one plasticizer.

17. Product in subdivided form according to claim 16, comprising from 5% to 10% by weight, relative to the weight of the additive (a), of at least (vi) one plasticizer.

18. Product in subdivided form according to any one of the preceding claims, having a Shore A hardness of at least 45.

19. Product in subdivided form according to any one of the preceding claims, having a Shore D hardness not greater than 65.

20. Product in subdivided form according to claim 19, having a Shore D hardness of between 20 and 60.

21. Product in subdivided form according to any one of the preceding claims, in which the additive (a) is chosen from the following classes:
(a1) crosslinking agents;
(a2) accelerators;
(a3) thermosetting resins;
(a4) activators;
(a5) retardants;
(a6) adhesion promoting agents;
(a7) protective agents;
(a8) coupling agents;
(a9) condensation catalysts.

22. Product in subdivided form according to any one of the preceding claims, in which, in the copolymer (i), the aliphatic α-olefin is an olefin of formula CH₂═CH—R, in which R represents a linear or branched alkyl group containing from 1 to 12 carbon atoms.

23. Product in subdivided form according to claim 22, in which the aliphatic α-olefin is chosen from propylene, 1-butene, isobutylene, 1-pentene, 4-methyl-1-pentene, 1-hexene, 1-octene, 1-dodecene, or mixtures thereof.

24. Product in subdivided form according to any one of the preceding claims, in which, in the copolymer (i), the aromatic α-olefin is an olefin of formula:
CH₂═CH—(R₁R₂C)ₓ—C₆H_{5-y}(R₃)_{y}
in which R₁, R₂ and R₃, which may be identical to or different from each other, represent hydrogen or a linear or branched alkyl group containing from 1 to 8 carbon atoms; or R₃, different from R₁ and R₂, represents an alkoxy group, a carboxyl group, an acyloxy group, said acyloxy group optionally being substituted with alkyl groups containing from 1 to 8 carbon atoms or hydroxyl groups or halogen atoms; x is 0 or an integer between 1 and 5 inclusive; y is 0, 1 or 2.

25. Product in subdivided form according to claim 24, in which the aromatic α-olefin is chosen from styrene, α-methylstyrene, or mixtures thereof.

26. Product in subdivided form according to any one of the preceding claims, in which, in the copolymer (i), the polyene is a diene, a triene or a tetraene, which may be conjugated or non-conjugated.

27. Product in subdivided form according to claim 26, in which the polyene is a diene.

28. Product in subdivided form according to any one of the preceding claims, in which the copolymer (i) may be obtained by copolymerization of ethylene with an aliphatic or aromatic α-olefin, and optionally a polyene, in the presence of a “single-site” catalyst.

29. Product in subdivided form according to any one of the preceding claims, in which the copolymer (i) is characterized by a density of between 0.86 g/cm³ and 0.93 g/cm³.

30. Product in subdivided form according to any one of the preceding claims, in which the copolymer (i) is characterized by a Mooney viscosity ML (1+4) at 125° C. of greater than 5.

31. Product in subdivided, form according to any one of the preceding claims, in which the copolymer (i) is characterized by a Melt Flow Index (MFI) of between 0.1 g/10 min and 35 g/10 min.

32. Product in subdivided form according to any one of the preceding claims, in which the copolymer (i) is characterized by a melting point (Tₘ) of between 50° C. and 120° C.

33. Product in subdivided form according to any one of the preceding claims, in which the copolymer (i) has the following composition: 50 mol %-97 mol % of ethylene; 3 mol %-50 mol % of aliphatic or aromatic α-olefin; 0 mol %-5 mol % of a polyene.

34. Product in subdivided form according to any one of the preceding claims, in which the copolymer (i) contains functional groups chosen from: carboxylic groups, anhydride groups, ester groups, silane groups, epoxide groups.

35. Product in subdivided form according to claim 8 or 9, in which the polymer (ii) is a polyoctenamer.

36. Product in subdivided form according to claim 8 or 9, in which the polymer (ii) is characterized by a percentage of double bonds in trans configuration of at least 60 mol %.

37. Product in subdivided form according to claim 8 or 9, in which the polymer (ii) is characterized by a melting point of between 25° C. and 80° C.

38. Product in subdivided form according to claim 10 or 11, in which the copolymer (iii) is a copolymer of ethylene with at least one ester containing an ethylenic unsaturation chosen from: alkyl acrylates, alkyl methacrylates and vinyl carboxylates, in which the linear or branched alkyl group contains from 1 to 8 carbon atoms, while the linear or branched carboxylic group contains from 2 to 8 carbon atoms.

39. Product in subdivided form according to claim 38, in which the copolymer (iii) is chosen from: ethylene/vinyl acetate, ethylene/ethyl acrylate, ethylene/butyl acrylate.

40. Product in subdivided form according to claim 12 or 13, in which the elastomeric polymer (iv) is an elastomeric polymer or copolymer containing an unsaturated chain, with a glass transition temperature of less than 20° C.

41. Product in subdivided form according to claim 40, in which the elastomeric polymer (iv) is chosen from: natural or synthetic cis-1,4-polyisoprene, 3,4-polyisoprene, polychloroprene, optionally halogenated isoprene/isobutene copolymers, 1,3-butadiene/acrylonitrile copolymers, styrene/1,3-butadiene copolymers, styrene/isoprene copolymers, styrene/isoprene/1,3-butadiene copolymers; or mixtures thereof.

42. Product in subdivided form according to claim 12 or 13, in which the elastomeric polymer (iv) is an elastomeric polymer of one or more monoolefins with an olefinic comonomer or a derivative thereof, said elastomeric polymer (iv) being characterized by a melting enthalpy (ΔHₘ) of less than 15 J/g.

43. Product in subdivided form according to claim 42, in which the elastomeric polymer (iv) is chosen from: ethylene/propylene copolymers or ethylene/propylene/diene copolymers; polyisobutene; butyl rubbers; halobutyl rubbers; or mixtures thereof.

44. Product in subdivided form according to claim 14 or 15, in which the reinforcing filler (v) is chosen from: carbon black, silica, alumina, aluminosilicates, calcium carbonate, kaolin and titanium dioxide, or mixtures thereof.

45. Product in subdivided form according to claim 16 or 17, in which the plasticizer (vi) is chosen from mineral oils such as paraffinic oils, naphthenic oils and aromatic oils; vegetable oils; or mixtures thereof.

46. Process for preparing a crosslinkable elastomeric composition, comprising the following stages:
mixing a base polymer comprising at least one elastomeric polymer with at least one reinforcing filler and at least one plasticizer;
adding at least one additive capable of modifying or improving the properties of said elastomeric composition;
mixing and dispersing said reinforcing filler, said plasticizer and said additive in said elastomeric polymer;
in which said at least one additive is added as a product in subdivided form comprising said at least one additive dispersed in a thermoplastic binder comprising at least (i) one copolymer of ethylene with at least one aliphatic or aromatic α-olefin, and optionally a polyene, said copolymer being characterized by a molecular weight distribution (MWD) index of less than 5, and a melting enthalpy (ΔHₘ) of at least 30 J/g.

47. Process according to claim 46, in which said process is carried out in continuous mode.

48. Process according to claim 46, in which said process is carried out in batchwise mode.

49. Process according to any one of claims 46 to 48, in which the elastomeric polymer is a natural or synthetic elastomer, which is optionally oil-extended.

50. Process according to claim 49, in which the elastomeric polymer is chosen from: natural rubber; butyl rubber; polybutadiene, polyisoprene; styrene/butadiene copolymers; butadiene/isoprene copolymers; styrene/isoprene copolymers; nitrile rubbers; ethylene/propylene copolymers, terpolymers of ethylene, of propylene and of non-conjugated dienes such as 5-ethylidene-2-norbornene, 1,4-hexadiene, cyclooctadiene or dicyclopentadiene, or mixtures thereof.

51. Process according to any one of claims 46 to 50, in which the reinforcing filler is chosen from carbon black, silica, alumina, aluminosilicates, calcium carbonate, kaolin, titanium dioxide, or mixtures thereof.

52. Process according to any one of claims 46 to 51, in which the plasticizer is chosen from mineral oils such as paraffinic oils, naphthenic oils, aromatic oils; vegetable oils; or mixtures thereof.

53. Process according to any one of claims 46 to 52, in which the product in subdivided form is defined according to any one of claims 1 to 45.
